(19) United States
(12) Patent Application Publication
(10) Pub. No.: US 2004/0090300 A1
(43) Pub. Date: May 13, 2004

(54) Ferrite cores with a new shape

(75) Inventors: Helko Meuche, Munich (DE); Mauricio Esguerra, Taufkirchen (DE)

Correspondence Address: SCHIFF HARDIN & WAITE, Patent Department, 6600 Sears Tower, 233 South Wacker Drive, Chicago, IL, 60606, US

(73) Assignee: EPCOS AG

(21) Appl. No.: 10/702,292

(22) Filed: Nov. 6, 2003

Related U.S. Application Data
(62) Division of application No. 09/772,833, filed on Jan. 30, 2001, now Pat. No. 6,696,913.

(30) Foreign Application Priority Data
Nov. 17, 2000 (DE) 100 56 945.5

(51) Int. Cl. H01F 27/24

(52) U.S. Cl. 336/212

(57) ABSTRACT

An improved ferrite core, which is particularly suitable for transformers, is proposed, which proposes with respect to shapes derived from E-cores to create the middle bleb with an oval cross-section, whereby the longitudinal axis of the middle bleb is oriented parallel to the attachment plane and the longest axis of the oval cross-section resides vertically to this attachment plane. The core is symmetrically structured with respect to the mirror plane, which contains the longitudinal axis and which resides vertically to the attachment plane, and is particularly low in distortion.

Ferrite cores can be applied in various ways in telecommunications and data technology. Specific material core combinations are required for data transmission standards such as xDSL or ISDN, since the properties of components having ferrite components are essentially dependent on the material and on the core shape of the ferrite core.

For example, ferrite cores are applied as broadband transformers for impedance adaptations; as splitters for separating the speech and data channel (POTS) or as a signal pulse transformer in digital telecommunication networks, in which digital signals or analog signals are transmitted with little distortion. The number of required components is increasingly rising in modern terminal devices of the telecommunication. At the same time, a further reduction of assemblies and modules is desired in order to further reduce the size and weight of the terminal devices and in order to thus improve the handling. Corresponding assemblies and modules, therefore have a continuously increasing packing density of the components. It is also desired to increase the packing density by selecting such components requiring less assembly surface on a base, such as a motherboard. Despite the minimization of the component measurements, performance and properties of the components are not to be impaired.

An EP13 ferrite core is currently the standard shape for xDSL transformers. Its behavior is good for a transmission with little distortion, an EP13 core has a beneficial core distortion factor, in particular. It represents a suitable variable for evaluating the distortion behavior and the nonlinear distortion factor. In order to reduce the surface need of the ferrite core, smaller cores than the EP13 core can be used, particularly standard shapes such as EP10 cores and EP7 cores. As a result of the reduced size, these cores also have a smaller middle bleb, which leads to a significantly higher core distortion factor for the component and therefore reduces the performance of the component and its suitability for data transmissions.

An object of the invention is to find a new shape for a ferrite core, which has a sufficiently good distortion behavior when the assembly surface is reduced and which has an improved core distortion factor vis-a-vis an equally sized core of standard shape.

This object is inventively achieved by a ferrite core having the feature of claim 1. Advantageous embodiments and applications of the invention derive from the further claims.

The inventive ferrite core is similar to the standard shape EP rerading its shape, therefore is composed of two core halves with a parting seam vertically to the assembly surface/attachment surface. As well as the EP core, the inventive ferrite core represents an intermediate form between an E-core and a shell core. Parallel to the attachment surface and the longitudinal axis, it has a middle bleb flanked by two side parts at both sides. An end piece transversely arranged relative to the longitudinal axis of the middle bleb connects middle bleb and side parts such that the bottom edges of middle bleb and side parts are arranged in a plane, which is parallel to the attachment plane. The core has a plane of symmetry vertically residing relative to the attachment plane and comprising the longitudinal axis. In contrast to known EP cores, the inventive ferrite core has a middle bleb with an oval cross-section, whose longest extent resides vertically to the attachment surface.

In a preferred embodiment of the invention, the inwardly facing surfaces of the side parts follow the oval cross-section of the middle bleb in a predominately constant distance and form a hollow space for accepting the winding body.

In contrast to a comparable standard shape having the same assembly surface, the performance of the inventive ferrite core is improved. This means that an inventive ferrite core can replace a ferrite core having a larger assembly surface with only insignificant losses given almost equal properties. On the basis of an inventive ferrite core, components allowing a higher packing density can be produced.

The ferrite core can be fashioned as a standard EP core regarding its outer measurements and can have a rectangular base parallel to the attachment plane. The hollow space between the middle bleb and the side parts, which serves the purpose of accepting a coil body with at least one winding, is partially shielded by the side parts. The side parts therefore have a greater height above the attachment plane than the middle bleb. The hollow space formed by the side parts is preferably not completely closed toward the top and has a maximum opening toward the bottom regarding the attachment plane, whereby said opening corresponds to the maximum diameter of the hollow space.

Advantages are already obtained by an inventive ferrite core when the cross-section of the middle bleb is higher and wider. Preferably, the longest diameter of the oval cross-section, which is vertically oriented relative to the attachment plane, corresponds to at least the 1.2-times of the shortest diameter measured parallel relative to the attachment plane. Inventive ferrite cores can have a middle bleb, whose cross-section has principal axes or, respectively, diameters that differ up to the factor 5.

An inventive ferrite core has a closed magnetic circuit, however, it is divided into two or, respectively, is fashioned from two core halves that are combined to an overall core along a parting seam in order to facilitate the installation of the coil body or, respectively, the winding. The complete ferrite core thereby preferably consists of two mirror-inverted halves, whose symmetry plane resides vertically to the attachment plane and vertically to the longitudinal axis. However, it is also possible to divide the ferrite core such that the middle blebs and side parts completely belong to one core half, whereas the second “core half” is only composed of a further end piece connecting the free ends of the middle blebs and side parts to one another. However, it is also possible to provide the parting seam of the inventive ferrite core at an arbitrary location transverse to the longitudinal axis, whereby core halves of different size arise.

For producing a transformer from the inventive ferrite core, a coil body with preferably two windings is pushed over the middle bleb and the magnetic circuit is closed by joining the two core halves. The coil body can also have fastening pins and contacting pins, which can serve the purpose of connecting the winding ends and of producing the electrical contact with the printed circuit board or with the module substrate. Holding parts such as straps, clamps or caps can assure that the core halves stick together.

The core can be provided at the middle bleb with an air gap or without an air gap and can be produced from different ferrite materials. The ferrite materials T38, T42, N26 and T55 known from the EPCOS data book are particularly preferred for signal transmissions.

The application of inventive ferrite cores, however, it not limited to the transmission of signals. They can also be used as power transformers and are also characterized by their good performance given an improved or, respectively, smaller assembly surface.

The invention is subsequently explained in greater detail on the basis of exemplary embodiments and the appertaining Figures.

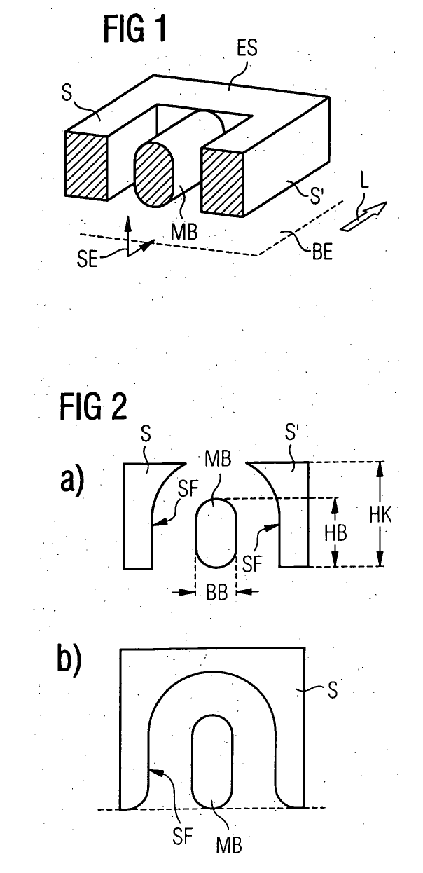

FIG. 1 schematically shows an inventive ferrite core

FIG. 2 shows inventive ferrite cores in a schematic cross-section

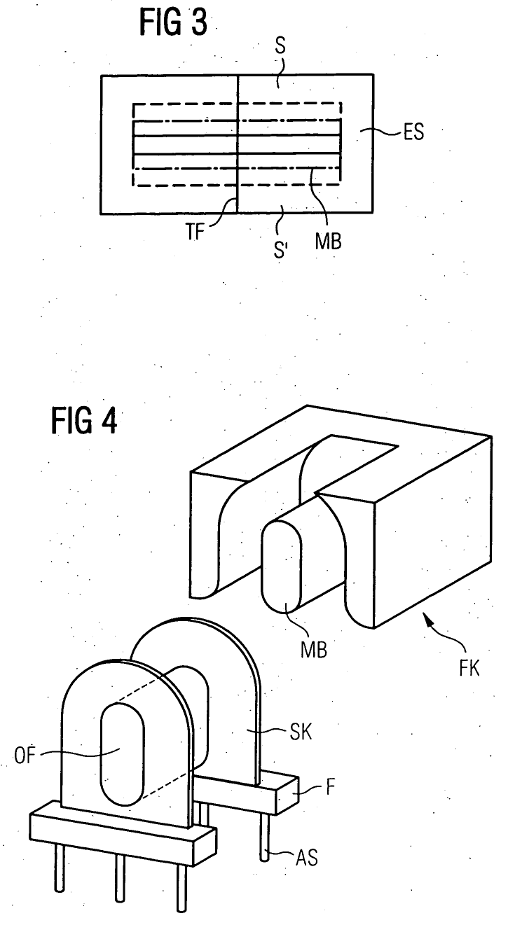

FIG. 3 shows a ferrite core in plan view from above

FIG. 4 shows a ferrite core with an appertaining coil body.

FIG. 1 shows an inventive ferrite core, wherein a middle bleb MB and two side parts are oriented parallel to a longitudinal axis L. An end piece ES connecting the side parts S, S′ and the middle bleb MB is transversely arranged relative to the longitudinal axis.

The entire core is fashioned mirror-inverted relative to a mirror plane SE, which extends through the center of the middle bleb and which contains the longitudinal axis L and which transversely resides relative to the attachment plane. The lower edges of the side part S, S′ and the middle bleb MB are situated on a plane parallel to the attachment plane BE. The middle bleb MB has an oval cross-section whose longest extent is vertically oriented relative to the attachment plane BE. The height of the side parts S and of the middle bleb MB is the same in the selected exemplary embodiment, but does not constitute a condition for inventive cores.

FIG. 2 shows further exemplary embodiments of inventive cores in a schematic, cross-section transverse to the longitudinal axis L. FIG. 2a shows an embodiment, wherein the height HK of the side parts S, S′ is greater than the height HB of the middle bleb. In contrast to the simplest exemplary embodiment shown in FIG. 1, the side surfaces SF of the side parts S, S′ facing the middle bleb are bent and follow the bend of the middle bleb MB with a correspondingly elongated radius of curvature. The side parts S, S′ correspondingly include a hollow space, whose inside surfaces follows [sic] the surface of the middle bleb and is correspondingly approximately ovally fashioned. The hollow space, which is formed by the side parts and which has a half-oval cross-section, however, is not entirely closed on top and has a maximum opening toward the attachment plane BE. The ratio HB to BB, therefore the ratio of the height of the middle bleb to the width of the middle bleb is situated between 1, 2 and 4 with respect to the inventive ferrite core.

FIG. 2b shows a ferrite core in schematic cross-section with a higher ratio FB to BB compared to FIG. 2. Moreover, the two side parts S are upwardly extended such that the hollow space enclosed by the side parts above the middle bleb is closed toward the top.

FIG. 3 shows an inventive ferrite core in plan view. A complete ferrite core has a closed magnetic circuit, whereby two core halves are inventively required therefor. In FIG. 3, two identical core halves are united along a parting seam TF to an overall core such that it has a further minor plane parallel to the parting seam TF in addition to the aforementioned mirror plane SE along the longitudinal axis L. The core shown in plan view corresponds to the core shown in FIG. 2a, wherein the width of the middle bleb MB (represented in broken lines in the Figure) is larger than the opening of the two side parts S, S′ facing upward. In addition to the shown symmetric dividing of the two core halves, it is possible to close the magnetic flow within one of the shown core halves not by an identical second core half but by a corresponding further end piece ES. All other unsymmetric dividing, wherein the two “core halves” have differently long side parts S and middle blebs MB, is certainly possible as well. For symmetry reasons, the symmetric dividing shown in FIG. 3 is preferred.

FIG. 4 schematically shows the corresponding core. A coil body SK is shown, which is separated from the ferrite core and which is pushed over the middle bleb and which serves the purpose of accepting a winding. For this purpose, the coil body SK has an opening OF corresponding to the cross-section of the middle bleb. The coil body has flanges F at the lower end, in which connection pins AS are fastened. The connection pins AS serve the purpose of connecting the windings arranged on the coil body SK and of fastening the overall arrangement composed of coil body, winding and ferrite core, for example a transformer.

For estimating the distortion behavior of an inventively fashioned ferrite core (as shown in FIG. 4), the geometry-related core distortion factor is calculated and compared with the corresponding values of the known standard shapes EP10 and EP13. A ferrite core having the outer measurements of the standard shape EP10 is produced, which has the inventive oval middle bleb. The characteristic values of the inventive EPX10 core cited ferrite core [sic] are contrasted with the values of the comparable standard shape EP10 and with the values of the next larger standard shape EP13.

| | EP 13 | EPX10 | EP10 |
|---|---|---|---|
| a [mm] | 12.5 | 11.5 | 11.5 |
| b [mm] | 8.8 | 7.6 | 7.6 |
| h1 [mm] | 12.85 | 10.20 | 10.20 |
| V_{assembly [mm}³] | 1413 | 890 | 890 |
| lₑ [mm] | 24.2 | 21.5 | 19.2 |
| Aₑ [mm²] | 19.5 | 15.1 | 11.3 |
| Aₘᵢₙ [mm²] (bleb) | 14.9 | 13.2 | 8.55 |
| Aₘₐₓ [mm²] (wall) | 49.0 | 31.2 | 37.8 |
| l_{N} [mm] | 23.8 | 24.3 | 21.5 |
| A_{N} [mm²] | 13.8 | 11.4 | 11.4 |
| CDF [mm^{-4, 5} ] | 0.191 | 0.333 | 0.506 |

In the table, a and b stand for externally measured width and height of the ferrite core, h1 for the length, V_{assembly} for the outside volume, lₑ for the effective magnetic wavelength of the ferrite core, Aₑ for the effective magnetic cross-section of the ferrite core, l_{N} for the average winding length of the coil body and A_{N} for the winding cross-section of the coil body. The core distortion factor CDF is calculated corresponding to a method presented on the MMPA User Conference, Chicago, September 1997 according to

$$CDF = \frac{\sum }{i} \frac{{l}_{i}}{{l}_{e}} \cdot \frac{{1}_{N}^{3 / 2}}{{A}_{N}^{3 / 2}} = \frac{{1}_{e}}{{A}_{e}^{2}} \cdot \frac{{1}_{N}^{3 / 2}}{{A}_{N}^{3 / 2}}$$

It shows that the inventive EPX10 core shows a significantly improved magnetic behavior and particularly a significantly improved core distortion factor—from 0.506-0.333 given the same outer measurements as an EP10 core. The low CDF of the EPX10 core therefore is close to the next larger standard shape EP13. It is thus clear that the shape and particularly the required assembly surface can be inventively reduced given the same magnetic values or, respectively, the magnetic values of a ferrite core can be significantly improved given the same shape and particularly the same assembly surface. This allows higher integration densities on modules and printed circuit boards, which are equipped with inventive ferrite cores or, respectively, with the components produced therefrom as transformed [sic].

Although the invention is only shown on the basis of a few representative exemplary embodiments, it is also within the framework of the invention to vary the core shape in a different way without deviating from the inventive idea. In particular, there are no limits with respect to the outside shape of the ferrite core, namely the shape of the side parts. However, the shown cubic outside shape has the advantage that it leads to ferrite cores having the best magnetic behavior regarding the given outside volume. The cubic outer measurements of inventive ferrite cores also preferred with respect to the space optimization given the installation, since it represents the most compact shape.

1. Ferrite core for a transformer with the features:
two side parts (S, S′) flank a middle bleb (MB) on both sides in a symmetric arrangement, they have the same length as the middle bleb given a ferrite core without an air gap or, given a ferrite core with an air gap, differ by its width from the length of the middle bleb, and extend along the longitudinal axis (L), of the ferrite core (FK) with a respectively constant cross-section, an end piece (ES) transversely arranged relative to the longitudinal axis connects the middle blebs and side parts such that the lower edges of the middle blebs and side parts are situated in a plane parallel to a later attachment plane (BE), the middle bleb has an oval cross-section without edges or corners, which has its longest extent vertically to the attachment plane,
the core is symmetrically structured with respect to a mirror plane (SE), which contains the longitudinal axis and vertically resides relative to the attachment plane.

2. Ferrite core according to claim 1,
wherein the inwardly facing surfaces (SF) of the side parts (S, S′) follow the oval cross-section of the middle bleb (B) in a predominately constant distance and form a hollow space for accepting a winding body (SK).

3. Ferrite core according to claim 1 or 2,
wherein the side parts (S, S′) above the attachment plane (BE)are higher than the middle bleb (MB).

4. Ferrite core according to one of the claims 1 to 3,
wherein the hollow space, which is formed by the side parts (S,S′) and which accepts the winding body (SK), has a maximum opening toward the bottom regarding the attachment plane (BE) and is mainly closed or entirely closed toward the top.

5. Ferrite core according to claim 1,
fashioned as an EP core having a rectangular circumference parallel to the attachment plane (BE) and cubic outside measurements.

6. Ferrite core according to one of the claims 1 to 5,
wherein the longest diameter of the oval cross-section of the middle bleb (MB) corresponds to the 1.2 to 5.0 times of the shortest diameter.

7. Ferrite core according to one of the claims 1 to 6,
which is symmetrically structure with respect to a mirror plane vertically residing relative to the attachment plane and the longitudinal axis.

8. Transformer with a ferrite core according to one of the claims 1-7, wherein the magnetic circuit in the core is closed with the aid of two core halves that are equally or similarly structured or with the aid of a second end piece and wherein a coil body (SK) with at least one winding is arranged above the middle bleb.

9. Utilization of a ferrite core according to one of the previous claims in a transformer for transmitting signals.

10. Utilization of a ferrite core according to one of the previous claims for a xDSL application as transformer for the impedance adaptation and for the insulation.

11. Utilization of a ferrite core according to one of the previous claims with the outer measurements of an EP 10 core instead of a traditional EP 13 core.
